(19) United States
(12) Patent Application Publication
(10) Pub. No.: US 2012/0247585 A1
(43) Pub. Date: Oct. 4, 2012

(54) PRESSURE REDUCING VALVE HAVING SHUTOFF MECHANISM

(75) Inventors: Taneaki MIURA, Saitama-shi (JP); Hiroyasu OZAKI, Utsunomiya-shi (JP); Koichi TAKAKU, Shioya-gun (JP); Koichi KATO, Utsunomiya-shi (JP)

(73) Assignee: HONDA MOTOR CO., LTD., Tokyo (JP)

(21) Appl. No.: 13/432,578

(22) Filed: Mar. 28, 2012

(30) Foreign Application Priority Data
Mar. 30, 2011 (JP) 2011-074824

(51) Int. Cl. G05D 16/06; F16K 1/38

(52) U.S. Cl. 137/505.36; 251/333

(57) ABSTRACT

A high-pressure side primary pressure chamber communicates with a secondary pressure chamber on the side of a pressure receiving device through a communication hole. A diaphragm which receives the pressure in the secondary pressure chamber is provided, and a valve body is connected to the diaphragm. The diaphragm is biased by a spring in a valve opening direction. The area S (mm²) of the pressure receiving surface of the diaphragm and the spring constant k (N/mm) of the spring are set so as to satisfy the following equations (1) and (2).

P1×S−k×ΔL>C (1)

P1<P2 (2)
where P1 denotes the pressure (MPa or N/mm²) of the secondary pressure chamber, ΔL denotes the displacement (mm) of the spring, C denotes the minimum closing load (N) of the valve body, and P2 denotes the allowable maximum pressure (MPa or N/mm²) of the pressure receiving device.

### CROSS-REFERENCE TO RELATED APPLICATION

Priority is claimed on Japanese Patent Application No. 2011-074824, filed Mar. 30, 2011, the disclosure of which is hereby incorporated herein by reference in its entirety.

### BACKGROUND OF THE INVENTION

1. Field of the Invention

The present invention relates to a pressure reducing valve which depressurizes a supply source side high-pressure fluid into a predetermined pressure and supplies the result to a low-pressure passageway provided with a pressure receiving device, and particularly, to a pressure reducing valve having a shutoff mechanism which has a function of preventing a high-pressure fluid of a low-pressure passageway from leaking to a supply source when a pressure receiving device stops.

2. Description of Related Art

In a fuel cell, a hydrogen tank filled with high-pressure hydrogen may be used as an anode-side fluid supply source. In a system which handles a high-pressure fluid, a pressure reducing valve is installed between a high pressure fluid supply source and a pressure receiving device, and the high-pressure fluid of the fluid supply source is supplied to the pressure receiving device while being depressurized into a predetermined pressure by the pressure reducing valve.

As a pressure reducing valve which is used for such a purpose, there is a known pressure reducing valve in which a diaphragm moving according to the pressure of a pressure receiving device is provided and a communication hole (a gas passageway) is opened and closed by a valve body moving together with the diaphragm. When the downstream side pressure decreases due to the use of the fluid in the pressure receiving device, the diaphragm of the pressure reducing valve moves according to a decrease in the pressure so that the valve body opens the valve. Then, the upstream-side high-pressure fluid flows toward the downstream side through the communication hole while being depressurized into a predetermined pressure.

Incidentally, since this kind of pressure reducing valve is designed to adjust (decrease) the pressure of the high-pressure fluid, the gap between the valve body and the valve seat (the peripheral edge portion of the communication hole) is not completely sealed. Further, when the flow of the fluid in the pressure receiving device stops for a long period of time, the upstream-side high-pressure fluid leaks to the downstream side where the pressure receiving device is provided through the gap between the valve body and the valve seat. Then, when the downstream-side pressure increases too much due to the leakage of the high-pressure fluid, there is a possibility that the downstream-side pressure may exceed the allowable maximum pressure of the pressure receiving device.

For this reason, when this kind of pressure reducing valve is used, a stop valve is provided on the upstream side or the downstream side of the pressure reducing valve so as to prevent the leakage of the high-pressure fluid using the stop valve.

Incidentally, when the pressure reducing valve and the stop valve are provided in parallel inside a pipe in this way, an installation space in the pipe increases, which inevitably increases the size of the system. Furthermore, the number of assembly steps increases with an increase in the number of installation components.

For this reason, as a pressure reducing valve solving such problems, a pressure reducing valve is proposed in which a stop valve function (a shutoff mechanism) is arranged inside a pressure reducing valve block (for example, see Japanese Unexamined Patent Application, First Publication No. H2-278315 and Japanese Patent No. 2858199).

### SUMMARY OF THE INVENTION

However, in the pressure reducing valve of the related art since plural types of valve mechanisms are assembled inside the pressure reducing valve block, the internal structure becomes complicated, which causes an increase in size or cost of a product.

Therefore, it is an object of the invention to provide a pressure reducing valve having shutoff mechanism capable of preventing the excessive leakage of a high-pressure fluid toward a pressure receiving device without complicating an internal structure.

Some aspects of the invention adopt the following means in order to solve the above-described problems.

(A) According to an aspect of the invention, a pressure reducing valve having a shutoff mechanism includes: a primary pressure chamber that is connected to a passageway on a high-pressure fluid supply source side; a secondary pressure chamber that is connected to a low-pressure passageway on a pressure receiving device side; a partition wall that separates the primary pressure chamber and the secondary pressure chamber from each other and has a communication hole communicating with the primary pressure chamber and the secondary pressure chamber; a diaphragm that has a pressure receiving surface receiving the pressure in the secondary pressure chamber and is displaced according to the pressure in the secondary pressure chamber acting on the pressure receiving surface; a valve body that is connected to the diaphragm so as to be displaceable together and opens the communication hole from the primary pressure chamber side; and a spring that biases the diaphragm in a direction in which the valve body opens the communication hole, wherein when the pressure in the secondary pressure chamber decreases so as to be a predetermined pressure or less, the valve body opens the communication hole, so that a high-pressure fluid flows from the primary pressure chamber to the secondary pressure chamber in a depressurized state, and wherein the area of the pressure receiving surface of the diaphragm and the spring constant of the spring satisfy the following equations (1) and (2).

P1×S−k×ΔL>C (1)

P1<P2 (2)

Where P1 denotes the pressure in the secondary pressure chamber when the valve body closes the communication hole, S denotes the area of the pressure receiving surface of the diaphragm, k denotes the spring constant of the spring, ΔL denotes the displacement from the free length of the spring. C denotes the minimum closing load of the valve body, and P2 denotes the allowable maximum pressure of the pressure receiving device.

Accordingly, when the valve body closes the communication hole so that the fluid in the pressure receiving device stops, the high-pressure fluid inside the primary pressure chamber slightly leaks to the secondary pressure chamber through the gap between the valve body and the communication hole. In this way, when the pressure in the secondary pressure chamber gradually increases and the thrust force acting on the diaphragm in the valve closing direction (the value on the left side of the equation (1)) exceeds the minimum closing load of the valve body (the value on the right side of the equation (1)), the valve body is closed by the thrust force, so that the leakage of the high-pressure fluid through the gap between the valve body and the communication hole is regulated. Then, as in the equation (2), the pressure (P1) of the secondary pressure chamber at this time becomes a value which is smaller than the allowable maximum pressure (P2) of the pressure receiving device.

(B) In the aspect (A), the valve body may be disposed so as to be coaxial with a valve seat of the peripheral edge of the communication hole. In the valve body and the valve seat, one of them may include a conical first contact surface and the other thereof may include an annular second contact surface of which an initial contact portion with respect to the first contact surface has a circular-arc cross-section. One of the first contact surface and the second contact surface may be formed of a resin and the other thereof may be formed of metal.

Accordingly, when the high-pressure fluid inside the primary pressure chamber slightly leaks to the secondary pressure chamber through the gap between the valve body and the valve seat in a state where there is no flow of the fluid in the pressure receiving device, so that the thrust force acting on the diaphragm in the valve closing direction increases with an increase in the pressure in the secondary pressure chamber, the valve body and the valve seat come into contact with each other at the conical first contact surface and the circular-arc cross-section portion of the second contact surface. When the thrust force acting on the diaphragm in the valve closing direction is comparatively small, the first contact surface and the second contact surface come into line-contact with each other. When the thrust force in the valve closing direction increases, the first contact surface and the second contact surface come into plane-contact with each other with the deformation of the resin.

According to the aspect (A), the area of the pressure receiving surface of the diaphragm and the spring constant of the spring are set so as to satisfy the equations (1) and (2), and the valve body is closed in the range where the pressure in the secondary pressure chamber acting on the diaphragm as the thrust force in the valve closing direction does not exceed the allowable maximum pressure of the pressure receiving device. Accordingly, it is possible to prevent the high-pressure fluid from excessively leaking to the pressure receiving device without further providing a valve mechanism dedicated for a stop valve. Thus, according the invention, it is possible to suppress an increase in size or cost of the product.

According to the aspect (B), the valve body and the valve seat come into contact with each other at the conical first contact surface and the annular second contact surface having the circular-arc cross-section portion. Then, one of the contact surfaces is formed of metal, and the other thereof is formed of a resin. Accordingly, when the thrust force in the valve closing direction is small, the first contact surface and the second contact surface come into line-contact with each other so as to close the valve. When the thrust force in the valve closing direction increases, the first contact surface and the second contact surface may come into plane-contact with each other by the deformation of the resin. For this reason, the gap between the valve body and the valve seat may be sealed by a comparatively small thrust force, and even when a large thrust force is exerted, degradation in the contact surface may be prevented by reliably sealing the gap between the valve body and the valve seat.

Then, according to the aspect of the invention, since the minimum closing load of the valve body may be decreased, the pressure receiving surface area of the diaphragm may be decreased, and hence the size of the apparatus may be decreased.

### BRIEF DESCRIPTION OF THE DRAWINGS

FIG. 1 is a schematic configuration diagram illustrating a fuel cell system which adopts a pressure reducing valve having shutoff mechanism according to an embodiment of the invention.

FIG. 2 is a cross-sectional view illustrating the pressure reducing valve having shutoff mechanism according to the same embodiment.

FIG. 3 is an enlarged diagram illustrating a part A of FIG. 2.

FIG. 4 is a cross-sectional view illustrating the pressure reducing valve having shutoff mechanism according to the same embodiment.

FIG. 5 is a cross-sectional view illustrating the pressure reducing valve having shutoff mechanism according to the same embodiment.

FIG. 6 is an enlarged diagram illustrating a part B of FIG. 5,

FIG. 7 is an enlarged diagram illustrating a modification of the part A of FIG. 2.

FIG. 8A is an enlarged diagram illustrating other modification of the part A of FIG. 2.

FIG. 8B is an enlarged diagram illustrating other modification of the part A of FIG. 2.

### DETAILED DESCRIPTION OF THE INVENTION

Hereinafter, an exemplary embodiment of the invention will be described by referring to the drawings.

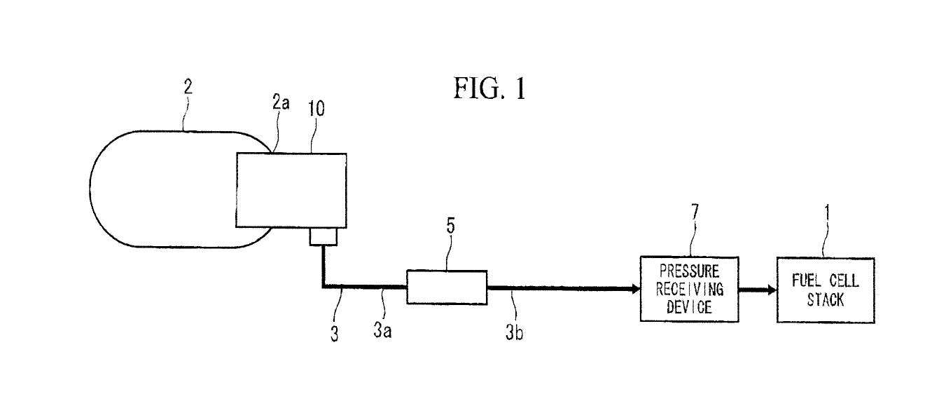

FIG. 1 is a schematic configuration diagram illustrating a fuel cell system, where reference numeral 1 denotes a fuel cell stack (a fuel cell) which generates electric power by receiving hydrogen as fuel and oxygen as an oxidizing agent. The fuel cell stack 1 is, for example, a polymer electrode fuel cell (PEFC), and is formed by stacking plural cells each of which is formed by sandwiching a membrane electrode assembly (MEA) using separators (not shown).

A hydrogen gas of a predetermined pressure and a predetermined flow rate is supplied from a hydrogen tank 2 (a high-pressure fluid supply source) storing high-pressure hydrogen to the fuel cell stack 1 through a hydrogen supply passageway 3, and air of a predetermined pressure and a predetermined flow rate is supplied to the fuel cell stack 1 through an air supply device (not shown).

The hydrogen tank 2 is formed in, a cylindrical shape of which both ends in the longitudinal direction are formed in a substantially semi-spherical shape and one end in the longitudinal direction is opened. A main stop valve 10 which is configured as a pilot-type electromagnetic valve is attached to an opening portion 2a. Hydrogen is supplied from the hydrogen tank 2 to the hydrogen supply passageway 3 through the main stop valve 10.

The hydrogen supply passageway 3 is provided with a pressure reducing valve having shutoff mechanism 5 (hereinafter, referred to as a “pressure reducing valve 5”) and a pressure receiving device 7. The hydrogen of a high pressure (for example, 35 MPa or 70 MPa) which is discharged from the hydrogen tank 2 is depressurized into a predetermined pressure (for example, 1 MPa or less) by the pressure reducing valve 5, and is supplied to the pressure receiving device 7. Here, the pressure receiving device 7 generally corresponds to a device which is disposed between the pressure reducing valve 5 and the fuel cell stack 1, and includes an ejector, an injector, a humidifier, and the like. The ejector is a device which returns a hydrogen off-gas to the hydrogen supply passageway 3 so as to use the hydrogen off-gas discharged from the fuel cell stack 1 in a circulating manner. The injector is a device which adjusts a flow rate of a hydrogen gas supplied to the fuel cell stack 1. The humidifier is a device which humidifies a hydrogen gas supplied to the fuel cell stack 1. Which device will be assembled as the pressure receiving device 7 is determined by the overall configuration of the fuel cell system.

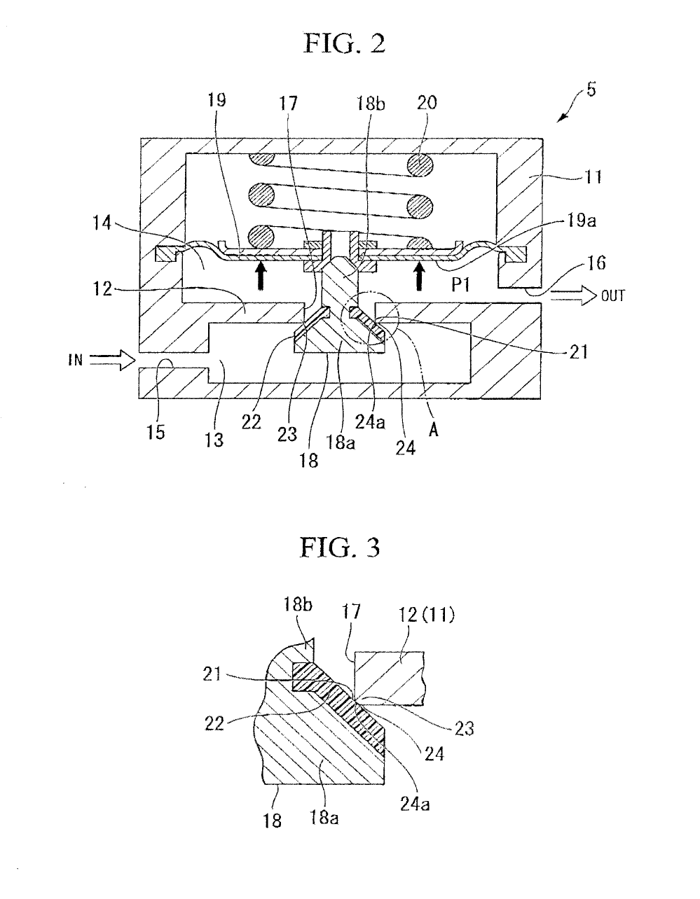

FIG. 2 is a diagram illustrating the detailed structure of the pressure reducing valve 5.

As shown in the same drawing, the pressure reducing valve 5 includes a primary pressure chamber 13 and a secondary pressure chamber 14 with a partition wall 12 interposed therebetween inside a valve housing 11. That is the partition wall 12 separates the primary pressure chamber 13 and the secondary pressure chamber 14 from each other. The primary pressure chamber 13 is connected to an upstream side 3a of the hydrogen supply passageway 3 (the side of the hydrogen tank 2) through an inflow port 15 of the valve housing 11, and the secondary pressure chamber 14 is connected to a downstream side 3b of the hydrogen supply passageway 3 (the side of the pressure receiving device 7) through an outflow port 16 of the valve housing 11. The partition wall 12 is provided with a communication hole 17 which communicates with the primary pressure chamber 13 and the secondary pressure chamber 14, and the communication hole 17 is opened from the side of the primary pressure chamber 13 by a valve body 18 to be described later.

Further, a diaphragm 19 is installed inside the valve housing 11 so as to be disposed in the secondary pressure chamber 14. In the diaphragm 19, the surface of which is disposed in the secondary pressure chamber 14, is a pressure receiving surface 19a, and a space portion on the rear surface side of the pressure receiving surface 19a is connected to the atmosphere. A valve shaft 18b of the valve body 18 which penetrates the communication hole 17 of the partition wall 12 is connected to the center portion of the diaphragm 19. The valve body 18 includes the valve shaft 18b which penetrates the inside of the communication hole 17 and a valve head portion 18a which extends to the end portion of the valve shaft 18h and opens and closes the end portion of the communication hole 17 on the side of the primary pressure chamber 13. Further, a spring 20 which biases the diaphragm 19 in a direction in which the valve body 18 opens the communication hole 17 is provided on the rear surface side of the diaphragm 19.

Here, the biasing force of the spring 20 and the pressure in the secondary pressure chamber 14 act on the diaphragm 19. In the valve body 18, when the pressure in the secondary pressure chamber 14 decreases so as to be a predetermined pressure or less due to the consumption (flow) of the hydrogen gas in the pressure receiving device 7, the valve head portion 18a opens the communication hole 17 with the reaction of the diaphragm 19, so that the high-pressure hydrogen gas flows from the primary pressure chamber 13 to the secondary pressure chamber 14 in a depressurized state.

FIG. 3 is an enlarged diagram illustrating the valve body 18 and the end portion of the communication hole 17 disposed in the primary pressure chamber 13.

As shown in the same drawing, in the valve body 18, the valve head portion 18a is formed so as to protrude in a conical shape toward the valve shaft 18b. The conical surface of the valve head portion 18a forms a first contact surface 21, and is formed by attaching a surface material 22 formed of a resin with elasticity to a metallic base surface. It is desirable that the resin which forms the surface material 22 have elasticity and sufficient durability. For example, polyamide-imide or the like is used.

On the other hand, the edge portion of the communication hole 17 on the side of the primary pressure chamber 13 is formed as a valve seat 23 where the valve head portion 18a of the valve body 18 comes into contact and separates. The entire valve seat 23 is formed of metal. Further, the valve body 18 is disposed so as to be coaxial with the valve seat 23.

In the valve seat 23, the corner of the end portion the communication hole 17 is chamfered in a circular-arc shape in the circumferential direction, and the portion is formed as a circular-arc cross-section 24a. In the case of the embodiment, the portion of the circular-arc cross-section 24a and the inner and outer edge portions are formed as a second contact surface 24. When the second contact surface 24 on the side of the valve seat 23 first comes into contact with the first contact surface 21 on the side of the valve body 18, the portion of the circular-arc cross-section 24a comes into line-contact with the first contact surface 21.

Furthermore, it is advantageous that the circular-arc cross-section 24a of the second contact surface 24 have the smaller curvature radius in order to maintain a sealing performance between the valve body 18 and the valve seat 23 even in a small pressure-contact load. However, it is desirable that the respective portions of the valve body 18 and the valve seat 23 be set according to the following ranges based on the balance with respect to the durability of the first contact surface 21 formed of a resin. For example,

Diameter of communication hole 17→3 mm to 8 mm

Conical angle of valve head portion 18a of valve body 18→60° to 120°

Curvature radius of circular-arc cross-section 24a of valve seat 23→0.1 mm to 0.5 mm

Incidentally, in the case of the pressure reducing valve 5, the area S (mm²) of the pressure receiving surface 19a of the diaphragm 19 and the spring constant k (N/mm) of the spring 20 are set so as to satisfy the following equations (1) and (2). In the pressure reducing valve 5, as described in detail later, the valve body 18 closes the communication hole 17 when the operation of the pressure receiving device 7 stops according to this setting.

P1×S−k×ΔL>C (1)

P1<P2 (2)

Here, P1 denotes the pressure (MPa or N/mm²) of the secondary pressure chamber 14 when the valve body 18 closes the communication hole 17, ΔL denotes the displacement (mm) from the free length of the spring 20, C denotes a minimum closing load (N) of the valve body 18, and P2 denotes the allowable maximum pressure (MPa or N/mm²) of the pressure receiving device 7.

In the above-described configuration, when the fuel cell is operated, the hydrogen gas inside the hydrogen tank 2 is depressurized into a predetermined pressure in the pressure reducing valve 5 and is supplied to the pressure receiving device 7. At this time, when the pressure in the secondary pressure chamber 14 decreases so as to be a predetermined value or less with the flow of the hydrogen gas in the pressure receiving device 7, in the pressure reducing valve 5, the diaphragm 19 is displaced in the valve opening direction. At this time, the valve body 18 opens the communication hole 17, so that the high-pressure hydrogen gas is supplied from the primary pressure chamber 13 to the secondary pressure chamber 14 in a depressurized state.

On the other hand, when the flow of the hydrogen gas in the pressure receiving device 7 stops due to the stopping of the operation of the pressure receiving device 7 or the like, first, the thrust force (P1×S) in the valve closing direction caused by the pressure P1 of the secondary pressure chamber 14 acting on, the diaphragm 19 becomes equal to the thrust force (k×ΔL) in the valve opening direction caused by the spring 20, and as shown in FIGS. 2 and 3, the valve body 18 slightly comes into contact with the valve seat 23.

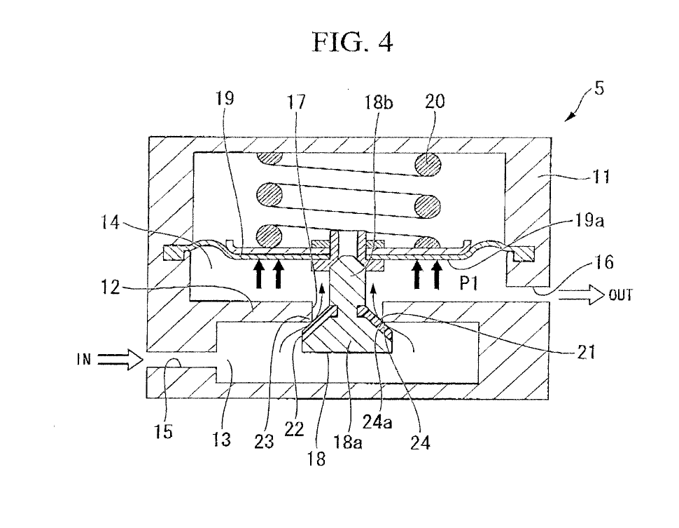

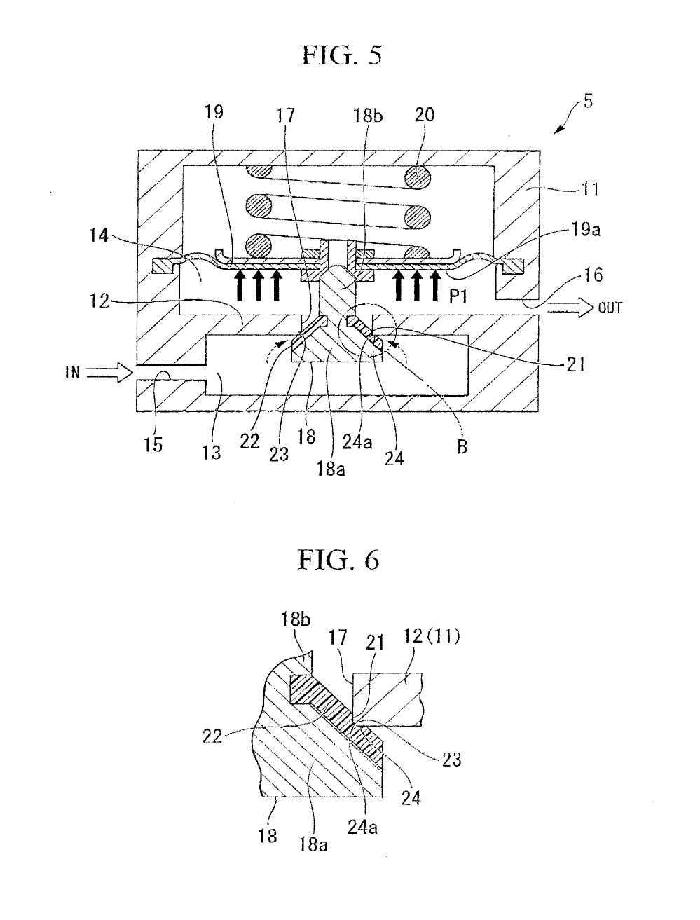

In this state, since the pressure-contact force between the valve body 18 and the valve seat 23 is small, as shown in FIG. 4, the high-pressure hydrogen gas of the primary pressure chamber 13 slightly leaks from the gap between the valve body 18 and the valve seat 23 toward the secondary pressure chamber 14 with the elapse of time, and the pressure P1 of the passageway in the secondary pressure chamber 14 and the pressure receiving device 7 gradually increases. In this way, when the pressure P1 of the secondary pressure chamber 14 increases up to a predetermined pressure, the difference between the thrust force (P1×S) in the valve closing direction caused by the pressure P1 of the secondary pressure chamber 14 acting on the diaphragm 19 and the thrust force (k×ΔL) in the valve opening direction caused by the spring 20 reaches the minimum closing load C of the valve body 18, and as shown in FIGS. 5 and 6, the gap between the valve body 18 and the valve seat 23 is sealed, so that the gap between the primary pressure chamber 13 and the secondary pressure chamber 14 is completely closed.

Then, since the pressure P1 of the secondary pressure chamber 14 at this time is set so as not to reach the allowable maximum pressure of the pressure receiving device 7 as in the above-described equation (2), even when the valve close state is maintained, the pressure receiving device 7 is not adversely affected by the pressure P1 of the hydrogen gas.

As described above, in the pressure reducing valve 5, only when the area S of the pressure receiving surface 19a of the diaphragm 19 and the spring constant k of the spring 20 are set so as to satisfy the equations (1) and (2), it is possible to prevent the pressure of the high-pressure gas of the primary pressure chamber 13 from acting on the pressure receiving device 7 in advance when the flow in the pressure receiving device 7 stops without further providing a valve mechanism dedicated for a stop valve. Thus, it is possible to suppress an increase in size and cost of the entire pressure reducing valve 5 by adopting the pressure reducing valve 5.

Further, in the pressure reducing valve 5 of the embodiment, the valve body 18 and the valve seat 23 come into contact with each other at the conical first contact surface 21 and the second contact surface 24 having the circular-arc cross-section 24a, the first contact surface 21 is formed of a resin with elasticity, and the second contact surface 24 is formed of metal. Accordingly, when the thrust force in the valve closing direction is small, as shown in FIGS. 2 to 4, when the first contact surface 21 and the second contact surface 24 come into line-contact with each other so as to close the valve and the thrust force in the valve closing direction increases, the first contact surface 21 and the second contact surface 24 may come into plane-contact with each other by the deformation of the resin as shown in FIGS. 5 and 6.

Thus, since the pressure reducing valve 5 may seal the gap between the valve body 18 and the valve seat 23 from the stage where the thrust force acting on the diaphragm 19 in the valve closing direction is comparatively small, it is possible to avoid an excessive increase in the pressure receiving surface area of the diaphragm 19 and realize a decrease in the size of the apparatus. Further, when the thrust force acting on the diaphragm 19 in the valve closing direction increases, the valve body 18 and the valve seat 23 come into plane-contact with each other, and hence degradation of the contact surface of the valve body 18 or the valve seat 23 may be prevented in advance.

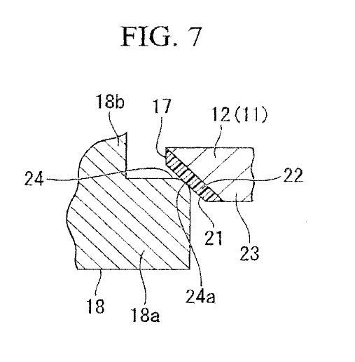

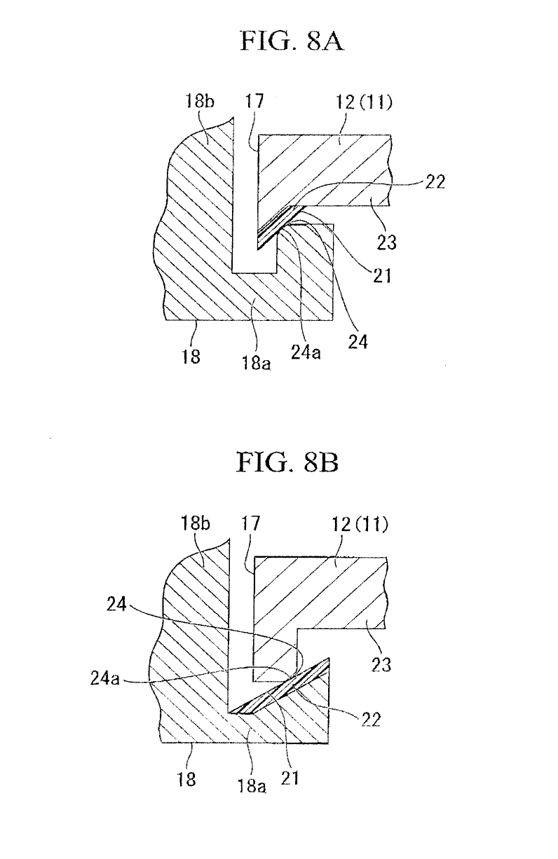

Furthermore, the invention is not limited to the above-described embodiments, and various modifications in design may be made without departing from the spirit of the invention. For example, in the above-described embodiment, the valve body 18 is provided with the conical first contact surface 21, and the valve seat 23 is provided with the second contact surface 24 having the circular-arc cross-section 24a. However, as shown in FIG. 7, the valve seat may be provided with the conical first contact surface, and the valve body may be provided with the second contact surface having the circular-arc cross-section. Further, as shown in FIGS. 8A and 88, the inclined direction of the conical shape may be opposite to that of FIGS. 3 and 7. Further, in the valve body side contact surface and the valve seat side contact surface, one of them may be formed of metal and the other thereof may be formed of a resin. Further, the valve body side contact surface may be formed of metal, and the valve seat side contact surface may be formed of a resin.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and

What is claimed is:

1. A pressure reducing valve having a shutoff mechanism comprising:
a primary pressure chamber that is connected to a passageway on a high-pressure fluid supply source side;
a secondary pressure chamber that is connected to a low-pressure passageway on a pressure receiving device side;
a partition wall that separates the primary pressure chamber and the secondary pressure chamber from each other and has a communication hole communicating with the primary pressure chamber and the secondary pressure chamber;
a diaphragm that has a pressure receiving surface receiving the pressure in the secondary pressure chamber and is displaced according to the pressure in the secondary pressure chamber acting on the pressure receiving surface;
a valve body that is connected to the diaphragm so as to be displaceable together and opens the communication hole from the primary pressure chamber side; and
a spring that biases the diaphragm in a direction in which the valve body opens the communication hole,
wherein when the pressure in the secondary pressure chamber decreases so as to be a predetermined pressure or less, the valve body opens the communication hole, so that a high-pressure fluid flows from the primary pressure chamber to the secondary pressure chamber in a depressurized state, and
wherein the area of the pressure receiving surface of the diaphragm and the spring constant of the spring satisfy the following equations (1) and (2).
P1×S−k×ΔL>C (1)
P1<P2 (2)
where P1 denotes the pressure in the secondary pressure chamber when the valve body closes the communication hole, S denotes the area of the pressure receiving surface of the diaphragm, k denotes the spring constant of the spring, ΔL denotes the displacement from the free length of the spring, C denotes the minimum closing load of the valve body, and P2 denotes the allowable maximum pressure of the pressure receiving device.

2. The pressure reducing valve having a shutoff mechanism according to claim 1,
wherein the valve body is disposed so as to be coaxial with a valve seat of the peripheral edge of the communication hole,
wherein the valve body includes a conical first contact surface and the valve seat includes an annular second contact surface of which an initial contact portion with respect to the first contact surface has a circular-arc cross-section, and
wherein one of the first contact surface and the second contact surface is formed of a resin and the other thereof is formed of metal.

3. The pressure reducing valve having a shutoff mechanism according to claim 1,
wherein the valve body is disposed so as to be coaxial with a valve seat of the peripheral edge of the communication hole,
wherein the valve seat includes a conical first contact surface and the valve body includes an annular second contact face of which an initial contact portion with respect to the first contact surface has a circular-arc cross-section, and
wherein one of the first contact surface and the second contact surface is formed of a resin and the other thereof is formed of metal.
